(19) United States
(12) Patent Application Publication
(10) Pub. No.: US 2006/0274325 A1
(43) Pub. Date: Dec. 7, 2006

(54) Method of qualifying a diffraction grating and method of manufacturing an optical element

(75) Inventors: Jochen Hetzler, Aalen (DE); Ulrich Andiel, Ulm (DE); Hartmut Brandenburg, Lauchheim (DE)

Correspondence Address: JONES DAY, 2882 SAND HILL ROAD, SUITE 240, MENLO PARK, CA, 94025, US

(73) Assignee: Carl Zeiss SMT AG, Oberkochen (DE)

(21) Appl. No.: 11/439,719

(22) Filed: May 23, 2006

Related U.S. Application Data
(60) Provisional application No. 60/684,138, filed on May 23, 2005.

(51) Int. Cl. G01B 9/02

(52) U.S. Cl. 356/521

(57) ABSTRACT

A method of qualifying a diffraction grating comprises performing plural measurements by illuminating a region of the grating with a beam of measuring light and detecting an intensity of measuring light diffracted by the grating into a 0th diffraction order. A wavelength of the measuring light or a polarization of the measuring light or an angle of incidence of the measuring light onto the diffraction grating is varied between subsequent measurements. A shape parameter of diffracting elements forming the grating comprises a pitch, height or width of structural features of the diffracting elements. The shape parameter is advantageously used in analyzing interferometric measurements performed on optical surfaces during manufacture of optical elements of a high accuracy.

This application claims the benefit under 35 U.S.C. § 119(e) of U.S. Provisional Patent Application No. 60/684,138, filed on May 23, 2005, the entire contents of which are incorporated herein by reference.

### BACKGROUND OF THE INVENTION

1. Field of the Invention

The present invention relates to a method of qualifying a diffraction grating and a method of manufacturing an optical element. In particular, the invention relates to a method of manufacturing an optical element having an aspherical shape.

2. Brief Description of Related Art

The optical element having the optical surface is, for example, an optical component such as an optical lens or an optical mirror used in optical systems, such as telescopes used in astronomy, and systems used for imaging structures, such as structures formed on a mask or reticle, onto a radiation sensitive substrate, such as a resist, in a lithographic method. The success of such an optical system is substantially determined by the accuracy with which the optical surface can be processed or manufactured to have a target shape determined by a designer of the optical system. In such manufacture it is necessary to compare the shape of the processed optical surface with its target shape, and to determine differences between the processed and target surfaces. The optical surface may then be further processed at those portions where differences between the machined and target surfaces exceed e.g. predefined thresholds.

Interferometric apparatuses are commonly used for high precision measurements of optical surfaces. Examples of such apparatus are disclosed in U.S. Pat. No. 4,732,483, U.S. Pat. No. 4,340,306, U.S. Pat. No. 5,473,434, U.S. Pat. No. 5,777,741, U.S. Pat. No. 5,488,477. The entire contents of these documents are incorporated herein by reference.

The conventional interferometer apparatus for measuring a spherical optical surface typically includes a source of coherent light and an interferometer optics for generating a beam of measuring light incident on the surface to be tested, such that wavefronts of the measuring light have, at a position of the surface to be tested, a same shape as the target shape of the surface under test. In such a situation, the beam of measuring light is orthogonally incident on the surface under test, and is reflected therefrom to travel back towards the interferometer optics. Thereafter, the light of the measuring beam reflected from the surface under test is superimposed with light reflected from a reference surface, and deviations of the shape of the surface under test and its target shape are determined from a resulting interference pattern.

While spherical wavefronts for testing spherical optical surfaces may be generated with a relatively high precision by conventional interferometer optics, more advanced optics, which are also referred to as compensators, null lens arrangements, or K-systems, are necessary to generate beams of measuring light having aspherical wavefronts such that the light is substantially orthogonally incident at each location of the aspherical surface under test.

Background information relating to null lens arrangements or compensators is available e.g. from Chapter 12 of the text book of Daniel Malacara “Optical Shop Testing”, 2^{nd} Edition, John Wiley & Sons, Inc. 1992.

The compensator for generating the aspherical wavefronts may comprise one or more refractive optical elements, such as lenses. It is also known to use a diffraction grating such as a hologram in a compensator for generating the aspherical wavefronts. Background information and examples of using diffraction gratings in interferometric measurements are illustrated in Chapters 15.1, 15.2, and 15.3 of the text book of Daniel Malacara mentioned above. The diffraction may be a real hologram generated by exposing a suitable material, such as a photographic plate, with interfering light beams, or a synthetic hologram, such as a computer generated hologram (CGH) generated by simulating the interferometer set up by a suitable computational method, such as ray tracing, and producing the hologram by manufacturing steps using a pen plotter and optical reduction, lithographic steps, laser beam recorders, electron beam recorders and others.

It has been found that the conventional methods of testing an optical surface using a diffraction grating have an insufficient accuracy in some applications.

### SUMMARY OF THE INVENTION

The present invention has been accomplished taking the above problems into consideration.

Embodiments of the present invention provide a method of testing and manufacturing an optical element having an optical surface of a high accuracy.

Further, embodiments of the present invention provide a method of testing and manufacturing an optical element having an aspherical surface of a relatively high accuracy.

Embodiments of the present invention provide a method of qualifying a diffraction grating.

Embodiments of the present invention provide a method comprising testing an optical element by using an interferometer optics having at least one diffraction grating or hologram for generating a beam of measuring light having suitable wavefronts for testing the optical surface of the optical element to be manufactured.

The diffraction grating is qualified by performing plural measurements on the diffraction grating, and at least one value representing a property of diffracting elements of the grating is determined in dependence of the plural measurements. The at least one determined value is then taken into account when the interferometric measurement of the optical element is analysed, and for example shape errors of the optical element are determined in dependence of the interferometric measurement and the at least one value representing the property of the diffraction grating.

The inventors have found that measurement errors of interferometric measurements of optical surfaces using an interferometer optics having a diffraction grating result from deviations of the grating from a specified design thereof.

While a line density of diffracting elements of the diffraction grating may be manufactured with a high accuracy according to a specification, other parameters of the diffraction grating, such as shape parameters of the diffracting elements, such as a pitch, a height of diffracting elements and a profile shape of the diffracting elements depend on parameters of a process used for manufacture of the diffracting grating. Such parameters are typically not reproducible with a sufficient accuracy to manufacture the diffraction grating with a sufficient accuracy according to its design.

To take account of deviations of the diffraction grating from its design, it is necessary to qualify the diffraction grating used in the interferometer optics after manufacture thereof. Conventional methods of qualifying a diffraction grating comprise measurements using an atomic force microscope (AFM), a scanning electron microscope (SEM) and an interference microscope. Such conventional methods are limited with respect to the time necessary for qualifying a typical diffraction grating and with respect to a precision with which profile shapes of the diffracting elements may be determined.

According to an embodiment of the invention, at least one value representing a property, such as a shape parameter, of the diffracting elements within a region is determined by performing plural measurements of that region, wherein each measurement comprises illuminating the region of the grating with a beam of measuring light and detecting an intensity of measuring light of the beam diffracted by the grating into a 0th diffraction order. Herein, the measuring light of the beam may have, in a first measurement, a wavelength which is different from a wavelength of the measuring light of the beam in a second measurement. As an alternative or in addition thereto the measuring light of the beam in the first measurement may have a polarization relative to the grating which is different from a polarization of the measuring light of the beam in the second measurement. As a further alternative, or in addition thereto, an angle of incidence of the first beam onto the grating in the first measurement may be different from an angle of incidence of the beam in the second measurement.

According to an embodiment of the invention, more than two measurements are performed wherein the measuring light of the beam is further varied in the additional measurements with respect to wavelength, polarization and angle of incidence.

Necessary differences of the wavelength, polarization and angle of incidence of the beam of measuring light in the different measurements may be determined by the person of ordinary skill in the art according to the application.

According to an embodiment of the invention, the wavelength of the measuring light may be varied by about 0.1% or more between subsequent measurements.

According to a further exemplary embodiment, the polarization of the light may be varied by more than 10% between different measurements. Herein, the polarization may be defined as a relative difference of intensities of light of the beam in a suitably chosen polarization direction in the first and second measurements. If the polarizations of the light in the two measurements are sufficiently different, there will exist a direction in which the polarization may be measured such that the above illustrated difference of intensities is fulfilled.

According to an exemplary embodiment of the invention, the polarization of the light of the beam in the first measurement is a substantially linear polarization with a polarization direction oriented parallel to a direction of extension of the diffracting elements within the illuminated region, and the light of the beam in the second measurement has also a substantially linear polarization which is, however, oriented transverse to the direction of extension of the diffracting elements in the illuminated region.

According to a further exemplary embodiment of the invention, the angle of incidence of the beam onto the grating differs by more than 10% between two different measurements.

The at last one parameter of the diffraction grating determined from the plural measurements may comprise a width of structures of the repetitively arranged diffracting elements within the illuminated region, a height of structures of the diffracting elements within the illuminated region or a pitch of structures of the diffracting elements within the illuminated region. The parameter may further comprise a slope of structural portions of the diffracting elements, a curvature of portions of the diffracting elements and others.

The parameter may be calculated from the plural measurements by using, for example one of the methods illustrated in the following publications: E. M. Drege et al., “Linearized inversion of scatterometric data to obtain surface profile information”, Opt. Eng. 41(1), 225, 2002; P. Latimer, “Determination of diffractor size and shape from diffracted light”, Applied Optics 17 (14), 1978; J. R. Marciante et al., “Optical measurement of depth and duty cycle for binary diffraction gratings with subwavelength features”, Applied Optics 42 (16), 3234, 2003. The full disclosure of these publications is incorporated herein by reference.

According to an embodiment of the invention, calibrating measurements are performed between subsequent measurements of the grating. The calibrating measurement comprises illuminating a portion of a substrate carrying the diffracting elements forming the grating outside of a region where the grating is formed, and detecting an intensity of measuring light having interacted with the substrate outside of the region where the grating is formed. The intensity detected in the calibrating measurement is taken into account when the at least one parameter is determined from the detected intensities of measuring light of the beam illuminating the region of the grating and being diffracted by the grating into the 0th diffraction order.

According to an embodiment of the invention the at least one parameter is determined for plural regions of the diffraction grating, wherein the plural regions may advantageously cover substantially the complete diffraction grating.

The plural regions may be subsequently measured by performing the plural measurements subsequently on each of their regions by displacing the grating relative to the beam between subsequent plural measurements.

According to an alternative embodiment, the plural regions of the grating are simultaneously measured by illuminating the plural regions with one single beam of measuring light and detecting 0th order diffracted light having interacted with the grating by a position sensitive detector.

The detected 0th order diffracted light may be light having traversed the grating or light reflected from the gratin.

With the above illustrated method it is possible to obtain shape parameters of the diffracting elements with a relatively high accuracy and within a relatively short measuring time and with a relatively high spatial resolution across the grating surface.

Such information on the element shape of the diffraction grating may be taken into account when analysing a diffracting pattern obtained in an interferometric measurement of an optical surface using an interferometer optics comprising the qualified diffraction grating.

A computer readable carrier containing a data structure representing results of the measurements of the grating is further provided. The computer readable carrier can be any suitable type of carrier such as a solid-state memory, a magnetic memory, optical memory, other type of memory or modulated waves/signals (e.g. radio frequency, audio frequency, or optical frequency modulated waves/signals) suitable for being transmitted through any suitable network, such as the internet.

Thus, it is possible that a user of a grating may send the grating to a laboratory or other institution to perform measurements on the grating according to the methods illustrated herein, for determining properties of the grating, such as shape parameters of diffracting elements of the grating, and a distribution of such properties across the grating. In particular, the result of the analysis may comprise a measured phase function representing the grating or a representation of wavefront errors generated by the grating. The laboratory or other institution may embody the results of the analysis in a data carrier which is sent back to the user together with the grating or separately therefrom. The user can then use the information represented by the data structure for improving results of his optical measurements using the grating.

Accordingly, an embodiment of the present invention provides a method of manufacturing an optical element having an optical surface of a target shape, wherein the method comprises: directing a beam of measuring light through an interferometer optics onto the optical surface, wherein the interferometer optics comprises a diffraction grating for diffracting the beam of measuring light and wherein at least one parameter of a shape of diffracting elements of the diffraction grating has been determined by performing the method of qualifying the diffraction grating according to the method illustrated above. The method of manufacturing the optical element further comprises performing at least one interferometric measurement by superimposing reference light with measuring light having interacted with the optical surface, determining deviations of the optical surface from the target shape based on the at least one interferometric measurement and the at least one determined parameter, and processing the optical surface of the optical element based on the determined deviations.

According to a further embodiment of the present invention, a method of manufacturing an optical element having an aspherical optical surface comprises performing at least one interferometric measurement by superimposing reference light with measuring light having interacted with the aspherical optical surface, using an interferometer apparatus comprising an interferometer optics including a hologram; and processing the optical surface of the optical element based on the at least one interferometric measurement and based on prestored data values indicative of phase errors produced by the hologram during the interferometric measurement.

The phase errors produced by the hologram during the interferometric measurement may be caused by deviations of a structure of the hologram from an ideal structure of the hologram determined by a design of the hologram. Such deviations may be caused by a process of manufacture of the hologram which results in a structure of the manufactured hologram which differs from the desired structure thereof. In particular, such deviations of the structure of the hologram include deviations of the structure of diffracting elements of the hologram, such as a width of the diffractive elements, a slope angle of side faces of the diffractive elements relative to a plane of extension of a carrier of the hologram and others.

According to an embodiment of the invention, the interferometer optics having the diffraction grating is designed such that the beam of measuring light is orthogonally incident on a mirror surface of the optical element at each location thereof, and the interferometer optics is designed such that wavefronts of measuring light emanating from the interferometer optics have wavefronts of a predetermined shape such that such condition is fulfilled. In practice, however, shapes of the diffracting elements will deviate from their design shapes, resulting in deviations of the wavefronts emanating from the interferometer optics from their desired shape. Such deviations may be calculated in terms of a wavefront error of the interferometer optics from information on the physical shapes of the diffracting elements. This information is obtained from the qualifying method illustrated above. The wavefront error of the interferometer optics is then taken into account when analysing the interferometric measurement performed on the optical element.

According to an exemplary embodiment of the invention, the diffraction grating is a phase grating configured such that a 0th order intensity of diffraction light of the measuring beam in the interferometric measurement is less than an intensity of the ±1st order light intensities. In particular, the 0th order diffracted light intensity is significantly suppressed relative to the ±1st order diffracted light intensities. In particular, an intensity of the 0th order diffracted light may be less than 10% of the intensity of the ±1st order diffracted light.

According to an exemplary embodiment herein, the wavelength of the measuring light for measuring the at least one shape parameter of the diffraction grating is different from the wavelength of the light used in the interferometric measurement of the optical surface. Such difference in wavelengths may have an advantage in generating different intensities in the measurements for qualifying the diffraction grating and thus has an advantage of an accurate analysis and determination of the shape parameters. In this respect, a sufficient difference between the wavelengths of the light used for determining the shape parameter of the grating and the light used for the interferometric measurement of the optical surface may be determined by the person of ordinary skill in the art depending on the application.

According to an exemplary embodiment of the invention, the interferometric measurement of the optical surface is performed with measuring light reflected from the optical surface to be tested. According to an alternative embodiment, the interferometric measurement is performed with light having traversed the optical surface to be tested.

According to a further exemplary embodiment, the optical surface to be tested is an aspherical surface having substantial deviations from a spherical shape. Within the context of the present application, an optical surface may be referred to as an aspherical surface if the aspherical surface differs from its best approximating sphere by more than a predetermined criterion. One such criterion is based on a gradient of the difference between the aspherical surface and its best approximating sphere, and the optical surface is referred to as an aspherical surface if such gradient exceeds a value of 6 μm divided by an effective diameter of the optical surface.

The processing of the optical surface may comprise a machining such as milling, grinding, loose abrasive grinding, polishing, ion beam figuring, magneto-rheological figuring, and finishing of the optical surface of the optical element.

According to an embodiment, the finishing comprises applying a coating to the optical surface. The coating may comprises a coating such as a reflective coating, an anti-reflective coating and a protective coating.

### BRIEF DESCRIPTION OF THE DRAWINGS

The forgoing as well as other advantageous features of the invention will be more apparent from the following detailed description of exemplary embodiments of the invention with reference to the accompanying drawings. It is noted that not all possible embodiments of the present invention necessarily exhibit each and every, or any, of the advantages identified herein.

FIG. 1 illustrates an interferometer system for testing an optical element according to an embodiment of a method according to the invention;

FIG. 2 illustrates a schematic representation of diffracting elements of a diffraction grating used in an interferometer optics of the interferometer system illustrated in FIG. 1;

FIG. 3 illustrates an intensity distribution in dependence of shape parameters of the diffractive elements shown in FIG. 2;

FIG. 4 shows an intensity distribution of diffracted light similar to that shown in FIG. 3;

FIG. 5 schematically illustrates an apparatus for measuring shape parameters of the diffracting elements of the diffraction grating shown in FIG. 2, according to an embodiment of the invention;

FIG. 6 shows a distribution of a specified line density of the diffraction grating used in the apparatus shown in FIG. 5;

FIG. 7 shows an intensity distribution across a surface of the grating measured with the apparatus in FIG. 5 using a first polarization of measuring light;

FIG. 8 shows an intensity distribution across a surface of the grating measured with the apparatus in FIG. 5 using a second polarization of measuring light;

FIG. 9 illustrates a distribution of an etching depth of the diffracting elements across the surface of the grating measured with the apparatus shown in FIG. 5;

FIG. 10 illustrates a distribution of a pitch of the diffracting elements across the surface of the grating measured with the apparatus shown in FIG. 5;

FIG. 11 shows a distribution of the etching depth of the diffracting elements of the diffraction grating across a surface thereof obtained from a measurement using an atomic force microscope;

FIG. 12 schematically illustrates a portion of a second embodiment of an apparatus for qualifying the diffracting grating used in the interferometer system shown in FIG. 5;

FIG. 13 schematically illustrates a portion of a system for testing an optical element according to a further embodiment of the invention; and

FIG. 14 is a flow chart of a method for manufacturing the optical element shown in FIG. 1.

### DETAILED DESCRIPTION OF EXEMPLARY EMBODIMENTS

In the exemplary embodiments described below, components that are alike in function and structure are designated as far as possible by alike reference numerals. Therefore, to understand the features of the individual components of a specific embodiment, the descriptions of other embodiments and of the summary of the invention should be referred to.

The exemplary embodiments of methods described below involve interferometrically taken measurements of wavefronts generated by reflecting an incident beam of measuring light provided by an interferometer apparatus from surfaces to be measured. Plural conventional interferometric methods may be used as a basis for taking such measurements. Examples of such interferometric methods are disclosed in e.g. U.S. Pat. No. 5,361,312, U.S. Pat. No. 5,982,490 and US 2002/0063867 A1. The entire contents of these patents and publications are incorporated herein by reference.

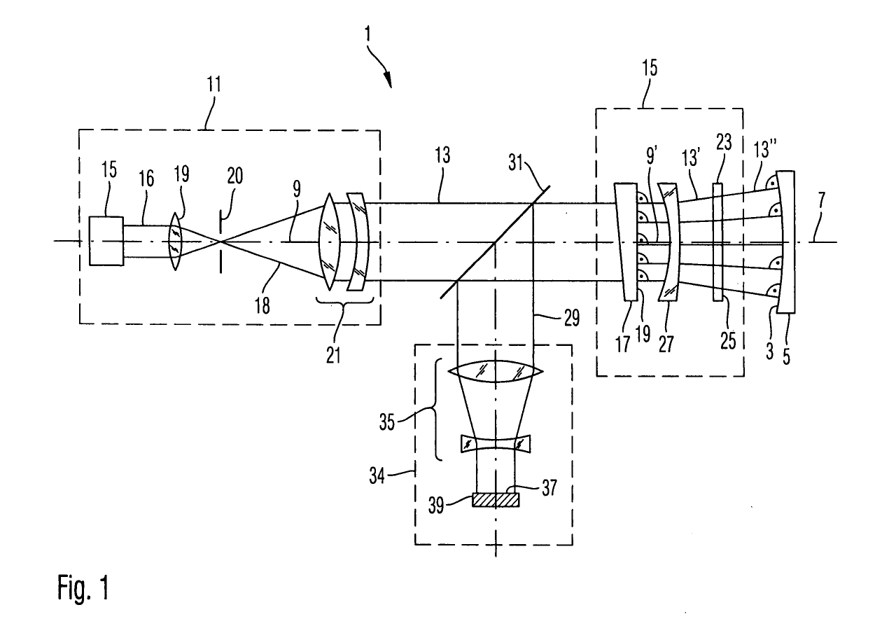

FIG. 1 schematically illustrates an interferometer system 1 for testing a surface shape of an aspherical mirror surface 3 of a mirror 5.

The interferometer system 1 comprises a light source 11 for generating beam 13 of measuring light. The light source 11 comprises a helium neon laser 15 emitting a laser beam 16 having a wavelength of 632.8 nm. Beam 16 is focused by a focusing lens 19 onto a pin hole aperture of a spatial filter 20 such that a diverging beam 18 of coherent light emerges from the pin hole. Wavefronts in diverging beam 18 are substantially spherical wavefronts. The diverging beam 18 is collimated by a group of lenses 21 having an optical axis 9, to form the parallel beam 13 of measuring light having substantially flat wavefronts. Beam 13 traverses an interferometer optics 15 which transforms and shapes the beam 13 of measuring light such that the beam 13″ supplied by the interferometer optics 15 and incident on the optical surface 3 has wavefronts of a shape which corresponds to a target shape of optical surface 3 at each position thereof. Thus, if the optical surface 3 is processed such that its surface shape corresponds to the target shape, the light of beam 13″ is orthogonally incident on the optical surface 3 at each location thereof. The light reflected from the optical surface 3 will then travel back exactly the same way as it was incident on the optical surface 3, traverse the interferometer optics 15, and a portion thereof will be reflected from a beam splitter 31 disposed in the portion of the beam 13 of measuring light where beam 13 is the parallel beam having the flat wavefronts. A beam 29 reflected from the beam splitter 31 is imaged onto a photo sensitive surface 37 of a camera chip 39 through an objective lens system 35 of a camera 34, such that the optical surface 3 is imaged onto the camera chip 39.

The interferometer optics 15 comprises a wedge shaped substrate 17 having a flat surface 19 which is oriented orthogonally to the parallel beam 13 of measuring light having traversed substrate 17. Surface 19 forms a Fizeau surface of interferometer system 1 in that it reflects a portion of the beam 13 of measuring light. The reflected portion of the beam 13 of measuring light forms reference light for the interferometric method. The reference light reflected back from Fizeau surface 19 travels back a same path as it was incident on surface 19, and is thus superimposed with the measuring light reflected from optical surface 3. The reference light is also deflected by beam splitter 31 and imaged onto the photo sensitive surface 37 of camera chip 39, such that an interference pattern generated by superimposing the wavefronts reflected from the optical surface 3 and the wavefronts reflected back from Fizeau surface 19 may be detected by camera 34.

As mentioned above, the interferometer optics 15 is designed such that it transforms the entering beam 13 of measuring light having the parallel wavefronts into the beam 13″ of measuring light having the aspherical wavefronts at the position of the optical surface 3. For this purpose, the interferometer optics 15 comprises a lens 27 transforming beam 13 into a diverging beam 13′ and a substrate 23 having two parallel flat surfaces wherein one surface 25 disposed opposite to the optical surface 3 carries the diffraction grating 25. The diffraction grating 25 is designed such that it diffracts the beam 13′ having the spherically diverging wavefronts substantially such that the wavefronts in the beam 13″ at the position of the optical surface 3 will have a shape which substantially corresponds to the target shape of the optical surface 3.

The diffraction grating may be a computer generated hologram (CGH) generated by calculating the grating using a computer, involving methods such as ray tracing and plotting the calculated grating on surface 25 of the substrate. The grating may be formed by a lithographic method and a forming method such as plasma etching, for example. Background information with respect to holograms used in interferometry may be obtained from Chapter 15 of the above mentioned text book of Daniel Malacara.

While the design of the diffraction grating 25 is calculated such that the above condition of orthogonal incidence of the measuring light 13″ on the optical surface 3 to be tested is fulfilled, the grating 25 manufactured according to such design will differ from that design in practice. Such differences may be caused by the manufacturing process used for manufacturing the grating 25. Such process may include steps such as plasma etching, and shapes of the diffracting elements resulting from such manufacture may differ from design shapes. In particular, structures of the diffracting elements may have a width or depth or pitch differing from the design of such structures. This results in wavefront errors of the light 13″ emanating from the interferometer optics 15 such that the condition of orthogonal incidence of the light is not perfectly fulfilled, resulting in a deviation of a detected interference pattern even though the optical surface 3 may have the desired target shape. Such wavefront errors have to be taken into account when analysing the detected interference patterns accordingly.

Thus, it is necessary to determine such wavefront errors. For this purpose, shape parameters of the diffracting elements of the diffraction grating 25 are measured by a method illustrated herein below.

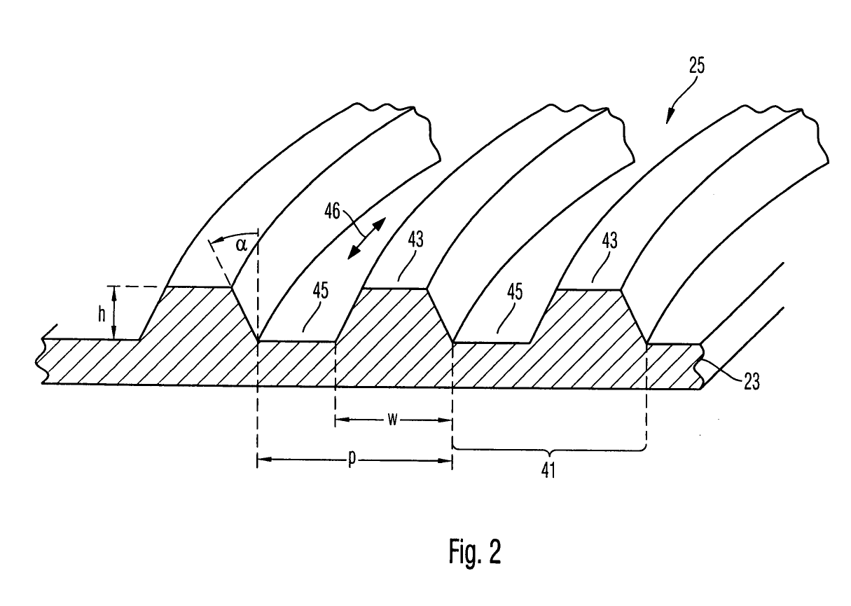

FIG. 2 is a schematic representation of an exemplary binary grating 25 provided on substrate 23. The grating comprises a plurality of diffraction elements 41 repetitively arranged on the substrate 23 with a pitch p. Each diffracting element 41 has a structure comprising a protrusion 43 and a groove 45, wherein the protrusions 43 project from the surface of the substrate 23 by a height h. The protrusions 43 have a width w which is smaller than the pitch p. Lateral walls of the protrusions are sloped surfaces defining a slope angle α relative to a plane oriented orthogonal to the substrate 23. The diffracting elements 41 extend on the surface of substrate 23 in a direction of extension which is indicated by an arrow 46 in FIG. 2. Within the relatively small illuminated region 53 the diffracting elements 41 and their structural features 43, 45 extend substantially parallel to each other along substantially straight lines. Further, within such sufficiently small region 53, the pitch p of the diffracting elements 41 may be assumed to be substantially constant, such that the pitch p may represent a local periodicity of the grating. However, the periodicity and direction of extension of the elements 41 will typically vary across the surface of the grating 25.

The diffraction grating 25 is a binary phase grating, wherein the height h is chosen such that 0th order diffracted light traversing the grating 25 is substantially suppressed.

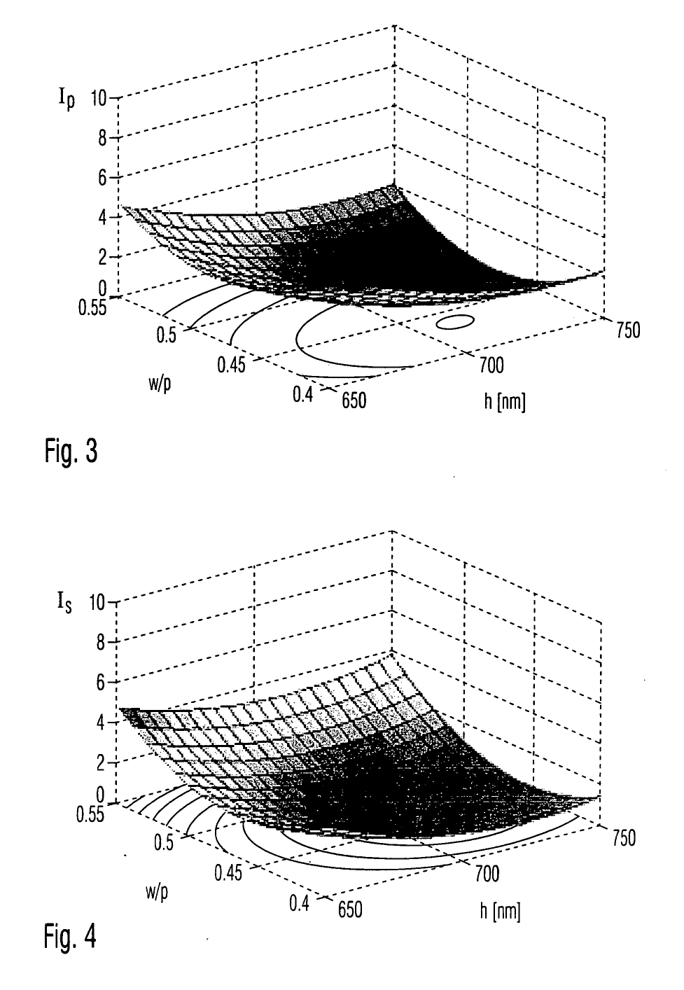

FIG. 3 shows a calculated intensity distribution of 0th order diffracted light traversing the grating wherein an angle of incidence of the beam is 90°. The intensity is plotted in dependence of the ratio w/p as a parameter and of the height h as a second parameter, wherein an orientation of the linear polarization of the incident light is such that an electric field vector E of the light is parallel to the direction 46 of extension of the diffracting elements on the surface of the substrate 23 within the illuminated region 53.

FIG. 4 is a representation of the intensity of the 0th order diffracted light similar to that shown in FIG. 3, wherein the orientation of the linear polarization is such that the electric field vector of the light is oriented transverse to the direction 46 of extension of the diffracting elements 43.

It is apparent from FIGS. 3 and 4 that, for a given value of w/p and h, the intensities Iₚ and Iₛ are different.

The intensities Iₚ and Iₛ shown in FIGS. 3 and 4 are calculated intensities for a line density of 250 diffracting elements per mm (p=1/250 mm⁻¹). Further details on intensity distributions of light beams diffracted by a grating may be taken from Y—C. Chang et al., SPIE Vol. 3782, 358, 1999.

By obtaining an intensity value Iₚ and and intensity value Iₛ by measurement on a region 53 of the grating 25 it is possible to determine both the values h and w/p from such measurements. In some situations it is possible that two different pairs of values w/p and h values result in the same values Iₚ and Iₛ, respectively. However, in practice, those values of w/p and h are sufficiently different from each other that one of these pairs of values may be excluded as a solution by practical considerations. It is in particular possible to perform an independent measurement by a method such as using an atomic force microscope at a small portion of the grating to determine those values of w/p and h which are with an applicable range of values in a particular measured grating.

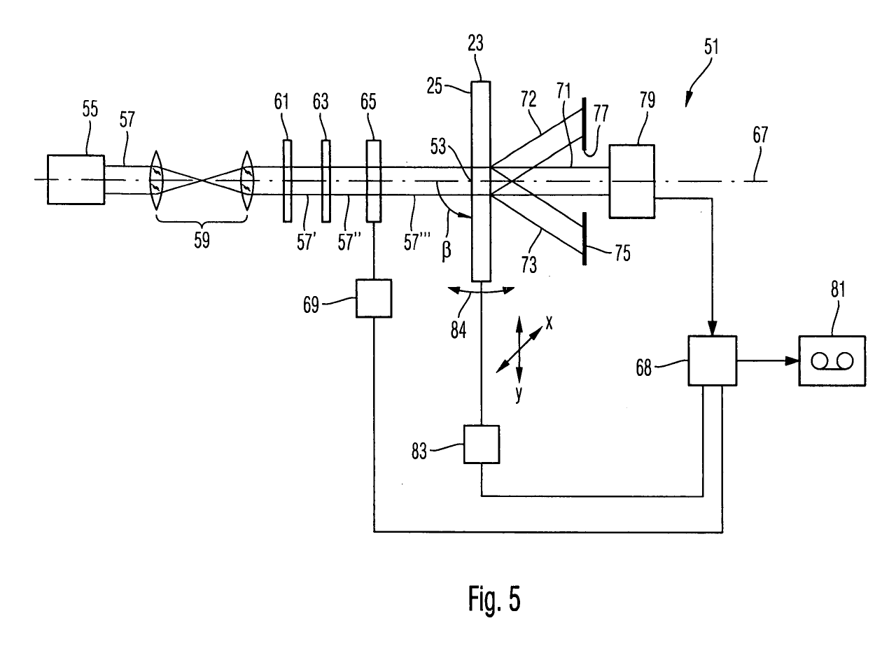

FIG. 5 schematically illustrates an apparatus 51 for measuring the values Iₚ and Iₛ in a region 53 of grating 25. The apparatus 51 comprises a laser light source 55. In the present example, the laser light source 55 is a He—Ne-laser emitting a beam 57 of measuring light which is collimated by a collimating optics 59 and is linearly polarized by a linear polarizer 61 to form linear polarized beam 57′. A wavelength of the measuring light is λ=633 nm. Other examples of possible light sources are a broadband light source, such as an arc-lamp, combined with a wavelength selective filter. A λ/4-plate 63 is disposed in the beam path of beam 57′ downstream of linear polarizer 61 to generate circular polarized light 57″. The beam 57″ of circular polarized light traverses a further linear polarizer 65 which is rotatable about an axis 67 of apparatus 51 by actuating a motor 69 under the control of the controller 68. Thus, the beam 57′″ having traversed polarizer 65 has an orientation of its linear polarization which may be selectively adjusted. The beam 57′″ having traversed polarizer 65 is incident on region 53 of grating 25. The beam 57′″ traversing the substrate 23 carrying the diffraction grating 25 is diffracted into a beam 71 of 0th diffraction order, a beam 72 of +1st diffraction order and a beam 73 of −1st diffraction order. Beams 72 and 73 are intercepted by a beam stop 75 having an aperture 77 allowing beam 71 to traverse therethrough and to be incident on a light detector 79. A light intensity detected by detector 79 is read out by controller 68. The controller 68 performs a first intensity measurement Iₚ when the polarizer 65 is oriented such that the direction of polarization is parallel to the direction 46 of extension of the diffracting elements 41 within the region 53. Thereafter, the controller 68 rotates the polarizer 65 such that the direction of polarization of the light incident on region 53 is oriented transverse to the direction 46 of extension of the diffracting elements 41 in the region 53, and the controller 68 obtains a next intensity value Iₛ.

From the two measurements Iₚ and Iₛ the controller 68 calculates the corresponding values w/p and h of the diffracting elements within region 53 and stores this pair of values together with coordinates x and y of region 53 on the grating surface on a data carrier 81. This calculation further depends on the line density 1/p and direction 46 of extension of the diffracting elements 41 in region 53. However, the line density and direction of extension is known with a sufficient accuracy in dependence of coordinates x, y from the design of the grating.

The calculation includes a solution of Maxwell's equation for a modal of the grating as it is known from the design of the grating. Such calculations are also referred to as rigorous analysis of diffraction on gratings. Background information on such type of calculations may be obtained from Alexander T. et al. “Rigorous coupled-wave analysis calculus of submicrometer interference pattern and resolving edge position versus signal-to-noise ratio”, Optical Engineering, Vol. 41, No. 8, August 2002, pages 1886 to 1892 and from Linfeng Li “New formulation of the Fourier modal method for crossed surface-relief gratings”, J. Opt. Soc. Am. A, Vol. 14, No. 10, pages 2758 to 2767. The entire contents of these documents are incorporated herein by reference.

Optimising methods may be used to determine the values of the properties of the diffracting elements, such as the line density 1/p and duty ratio w/p such that the measuring results correspond to simulated results obtained from the rigorous modal.

Thereafter, the controller 68 actuates a drive motor 83 to displace the substrate carrying the diffraction grating 25 relative to the beam 57′″ such that also the illuminated region 53 is displaced on the surface of the grating 25. Thereafter, new values Iₚ and Iₛ are obtained by measurements as illustrated above, and results of the values w/p and h are stored on the storage medium 81 together with the current coordinates x and y of the currently illuminated region 53.

Such procedure is repetitively performed until substantially the whole surface of the diffraction grating 25 has been tested. Thereafter, complete maps of w/p and h are stored on storage medium 81.

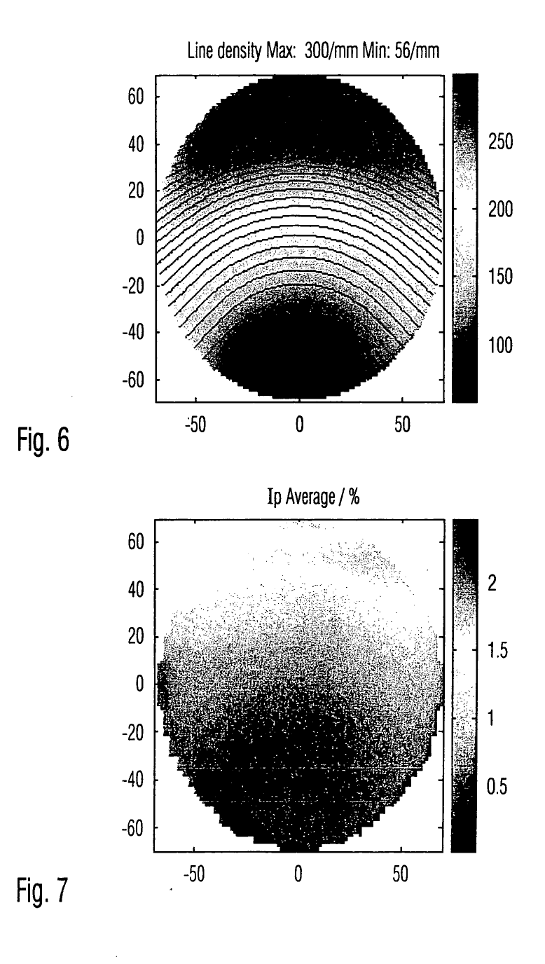

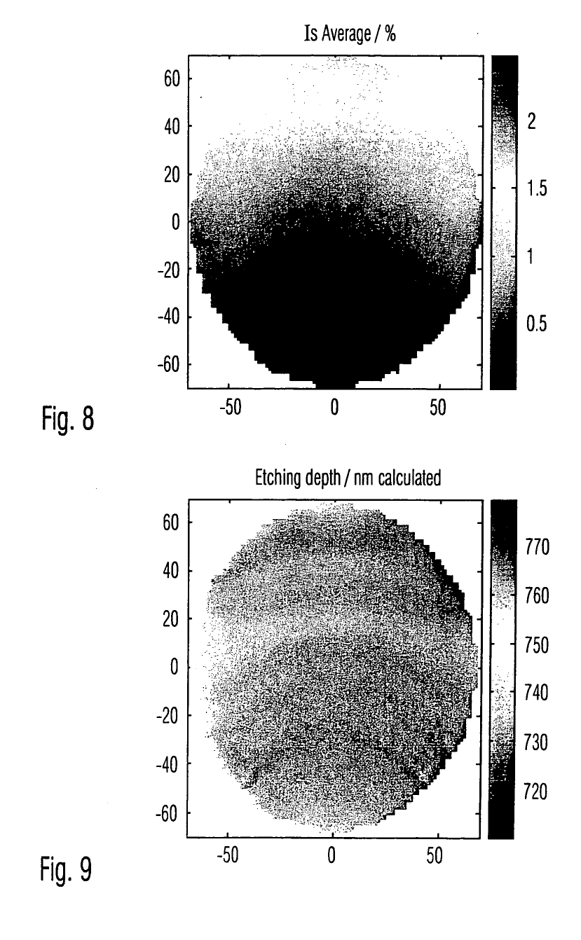

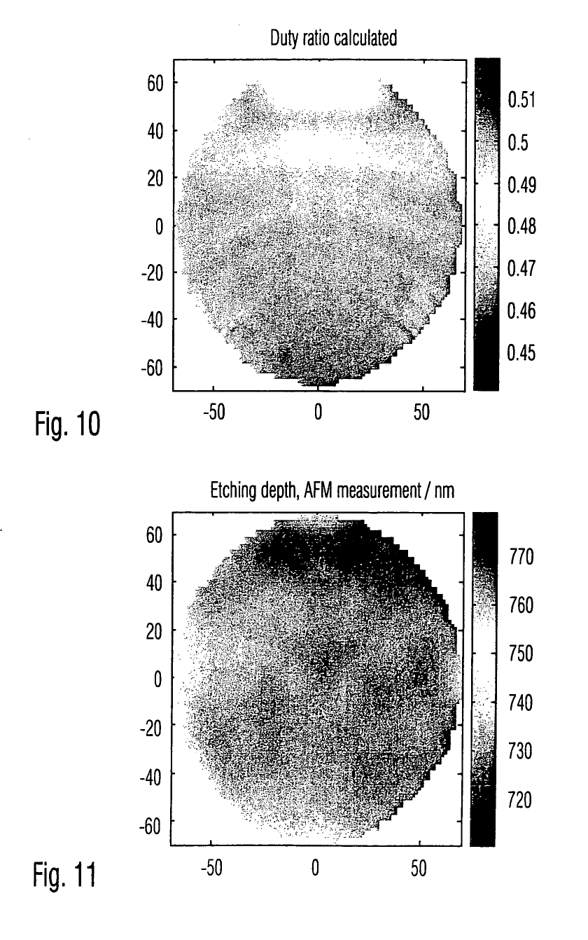

Results of such measurements are illustrated in FIGS. 6, 7, 8, 9 and 10. FIG. 6 is a representation of a map of a line density of a grating 25. FIG. 7 is a map of measured intensities Iₚ across the surface of the grating 25, FIG. 8 is a representation of a map of measured intensities Iₛ across the surface of the grating, FIG. 9 is a representation of a map of the calculated height values h across the surface of the grating, FIG. 10 is a map of calculated values w/p across the surface of the grating.

FIGS. 9 and 10 also indicate Zernike coefficients Z1 Z4, Z9, Z16, Z25, Z36, Z49 obtained from a numerical approximation of the respective map with Zernike polynomials.

FIG. 11 shows, for comparison, a map of the height h across the surface of the grating, wherein the map shown in FIG. 11 is obtained by a comparative measurement using an atomic force microscope (AFM). FIG. 11 also indicates the corresponding approximating Zernike coefficients, and a comparison of FIGS. 9 and 11 reveals that the map of h obtained with the apparatus 51 shown in FIG. 5 corresponds well with the map obtained with the atomic force microscope. However, a time necessary for obtaining the map using the apparatus 51 is much less as compared with a time necessary for obtaining the corresponding map using the atomic force microscope.

The stored maps of the w/p and h are then used to calculate wavefront errors of beam 13″ emanating from interferometer optics 15 of interferometer optics 1 shown in FIG. 1. These wavefront errors are taken into account when analysing the interferometric measurements obtained from optical surface 3 using the interferometer apparatus 1. A suitable data structure representing the wavefront errors is also stored on the data carrier 81.

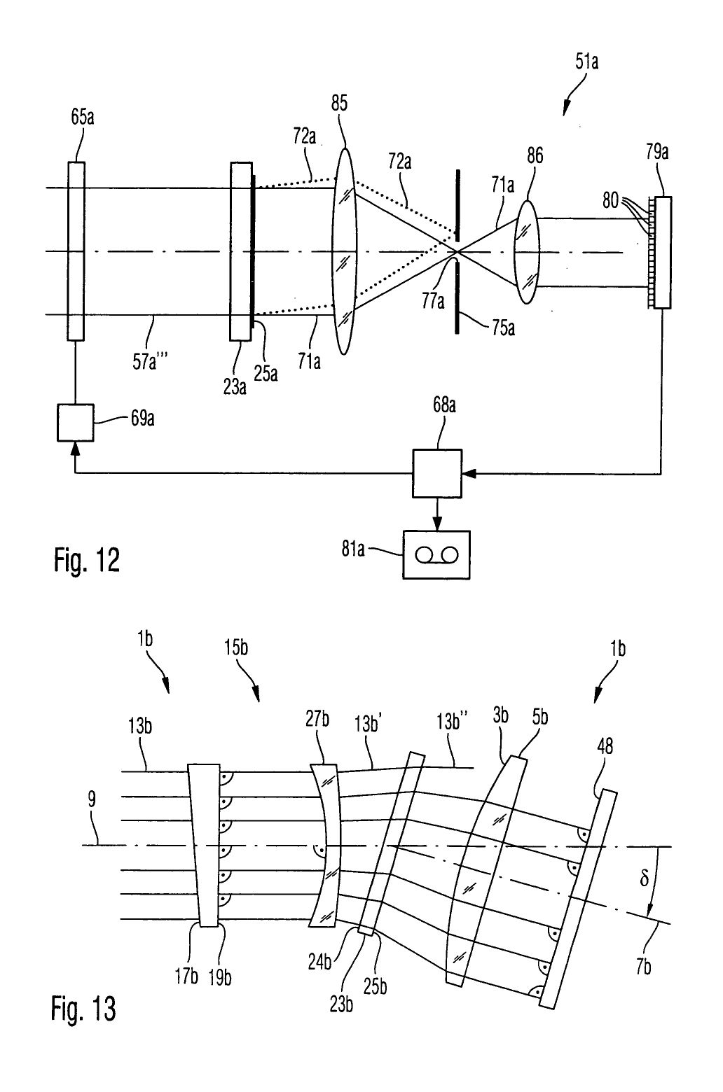

FIG. 12 shows a schematic representation of a further embodiment of an apparatus 51a for qualifying a diffraction grating 25a provided on a substrate 23a. A polarized beam 57a′″ of measuring light is incident on substantially a whole surface of grating 25a. Beam 57a′″ is diffracted into a 0th order beam 71a and higher order beams, wherein a 1^{st} order diffracted beam 72a is shown in FIG. 12. An imaging optics comprising lenses 85, 86 is provided for imaging the surface of diffraction grating 25a onto a two-dimensional position sensitive detector 79a using the 0th order diffracted light beam 71a. Detector 79a has a plurality of detecting elements or pixels 80. The 1st order diffracted beam 72a is intercepted by a beam stop 75a disposed in the beam path between lenses 85 and 86.

A linear polarizer 65a is disposed in the beam path of the measuring light upstream of the diffraction grating 25a, wherein an orientation of the linear polarization of beam 57a′″ is controlled by a controller 68a operating a motor 69a for rotating the linear polarizer 65a. For at least two different polarizations of the light of beam 57a′″ the controller 68a obtains complete maps of the intensity distribution of the 0th order diffracted light traversing the grating 25a, and these maps are stored on a storage medium 81a.

At least two images or maps of the detector 79a are obtained for different polarization directions of beam 57a′″ incident on the diffraction grating 25a. However, if a portion of the grating has grating structures arranged such that a direction of extension thereof has substantially the same orientation with respect to the two different polarization directions of the beam, a sufficient contrast between the two measurements is not guaranteed within these regions. In such situation it is advantageous to perform a third or further measurement with a third orientation of the incident beam 57a′″, which third orientation is different from the first and second orientations.

In the embodiment of the interferometer system illustrated with reference to FIG. 1 above, the light used for the interferometric measurement is measuring light reflected from the optical surfaces to be tested.

FIG. 13 illustrates an embodiment where the light used for the interferometric measurement and superimposed with reference light traverses an optical surface 3b of an optical element 5b to be tested. For this purpose, similar to the embodiment shown in FIG. 1, an interferometer optics 15b of an interferometer system comprises a Fizeau surface 19b, a diverging lens 27b and a diffraction grating 25b. The diffraction grating 25b has a carrier frequency such that a beam 13b′ of measuring light is deflected by the diffraction grating 25b by a relatively large angle δ. Details on carrier frequency holograms may be taken from the co-pending patent application Ser. No. 10/845,251, the disclosure of which is incorporated by reference.

The optical surface 3b to be tested is disposed downstream of diffraction grating 25b, and the measuring light traverses optical surface 3b and the whole optical element 5b, which is a lens, such that the light having traversed optical element 5b is orthogonally incident on an flat mirror 48. The light incident on the mirror 48 travels back, traversing optical element 5b, diffraction grating 25b, lens 27b and Fizeau surface 19b, where the light is superimposed with reference light reflected from 19b.

The diffraction grating 25b is designed such that the beam 13b′ emerging from the hologram is transformed by the optical element 5b having an optical surface 3b of the target shape to the parallel beam which is orthogonally incident on mirror 48.

In the embodiment illustrated in FIG. 13 the optical surface 3b is tested in transmission, i.e. the measuring light which is used for interfering with the reference light has transmitted the optical surface.

Each of the embodiments illustrated with reference to FIGS. 1 and 13 above may be modified such that the optical element under test is an off-axis element.

In the method illustrated above with reference to FIG. 5, the polarization direction of the beam 57′″ is changed between measurements for obtaining at least two independent measurements of a region of the grating. From such at least two independent measurements it is possible to determine at least one shape parameter of the grating, such as the values h and w/p. It is, however, possible to vary other properties than the polarization direction of the incident beam 57′″ between measurements. Examples of such other properties are the wavelength of the light emitted by light source 55 and an angle of incidence β of the beam 57′″ onto the grating 25. The angle of incident β may be varied by operating an actuator for tilting the substrate 23 as indicated by arrow 84 in FIG. 5. The wavelength of the measuring light may be suitable changed by using a suitable light source such as an external cavity diode laser (ECDL). Further, it is possible to determine other combinations of shape parameters than h and w/p from the measurements. Such combinations may include other shape parameters, such as the surface angle α, a curvature of edges formed on the grating structures and others.

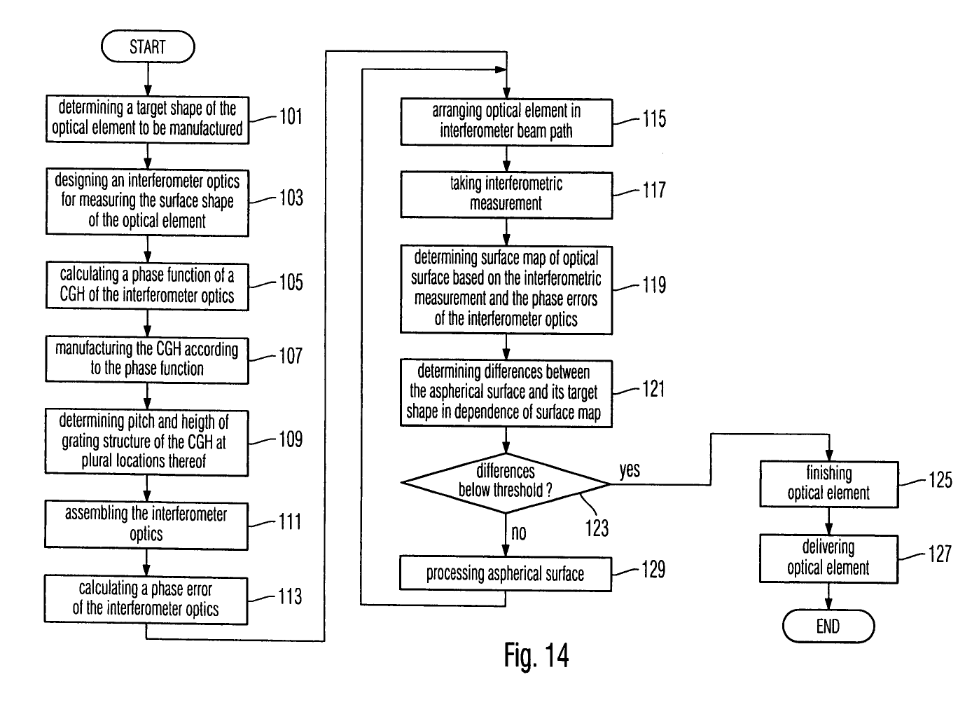

A method of manufacturing the optical surface 3 to a high accuracy using an interferometer system as illustrated above is illustrated with reference to the flowchart shown in FIG. 14. The procedure shown in the flow chart represents a part of a more comprehensive task of manufacturing an optical system having plural optical elements. One of these optical elements is mirror 5 shown in FIG. 1. A target shape of the mirror surface 3 is determined during the design step of the complete optical system in a step 101 of FIG. 14. The target shape is an aspherical shape. For manufacturing the optical system with a high accuracy, it is necessary that also the accuracy of the manufactured mirror 5 is maintained. For this purpose, the interferometer optics 15 of FIG. 1 is designed for testing mirror surface 3 in a step 103. Since the surface 3 to be tested has an aspherical target shape, it is advantageous to use diffraction grating 25 as an optical component of the interferometer optics 15. To fulfill the requirement of orthogonal incidence of the measuring light onto surface 3 under test, a corresponding phase function of the diffraction grating is calculated in a step 105. The calculated phase function is used in a process of manufacture of the diffraction grating in a step 107. The diffraction grating is a synthetic hologram, which is also referred to as a computer generated hologram (CGH). During the design of the diffraction grating it is assumed that a shape of the structural features of the diffracting elements is a substantially predetermined shape, such as the shape shown in FIG. 2 wherein the protrusions 43 and grooves 45 have a rectangular shape. Due to conditions of manufacturing the synthetic hologram, it is in practice not possible to obtain the desired predefined shapes of the diffracting elements in practice. Thus, the manufactured diffraction grating 25 will deviate from its perfect design configuration. To take optical effects, such as a diffraction effect, of the manufactured diffraction grating 25 into account, representative parameters, such as a pitch and height of its structural features are determined in a step 109 by a method as illustrated above with reference to FIGS. 3 to 12. Thereafter, the substrate 23 carrying the diffraction grating 25 is assembled with the other components, such as a Fizeau surface, to provide the interferometer optics 15 in a step 111. Further, phase errors of the interferometer optics 15 are calculated in a step 113, wherein the phase errors are determined in dependence of the shape parameters calculated in step 109. Such calculation may comprise computational methods such as ray tracing and calculations of diffraction efficiencies such as the methods disclosed in E. M. Drege et al., “Linearized inversion of scatterometric data to obtain surface profile information”, Opt. Eng. 41(1), 225, 2002; P. Latimer, “Determination of diffractor size and shape from diffracted light”, Applied Optics 17 (14), 1978; J. R. Marciante et al., “Optical measurement of depth and duty cycle for binary diffraction gratings with subwavelength features”, Applied Optics 42 (16), 3234, 2003.

Thereafter, the optical element 5 is arranged in the beam path of beam of measuring light in a step 115, and a counter n is set to zero in a step 115.

At least one interferometric measurement is performed with the optical element 3 arranged in the beam path of the interferometer system 1 in a step 117. From the one or more interference patterns obtained by such measurement, a surface map of the optical surface is determined in a step 119. Such calculation is also based on the phase errors of the wavefronts of beam 13″ emanating from interferometer optics 15 and calculated in step 113 above.

Differences between the measured shape of the optical surface and its target shape are calculated in a step 121, based on the surface map determined in step 119. In a step 123, a decision is made as to whether the tested aspherical surface corresponds to the specification for the finished optical surface. If the differences are below suitably chosen thresholds, a finishing step 125 is performed on the optical surface. The finishing may include a final polishing of the surface or depositing a suitable coating, such as a reflective coating, an anti-reflective coating, and a protective coating applied to the optical surface by suitable methods, such as sputtering. The reflective coating may comprise, for example, a plurality of layers, such as ten layers of alternating dielectric materials, such as molybdenum oxide and silicon oxide. Thicknesses of such layers may be about 5 nm and will be adapted to a wavelength to be reflected from the optical surface, such that a reflection coefficient is substantially high. Finally, the reflective coating may be covered by a protective cap layer for passivating the reflective coating. The cap layer may include a layer formed by depositing materials such as ruthenium. The anti-reflective coating which is intended to reduce reflections of radiation from the optical surface of the optical element, such as a lens element, may include materials, such as magnesium fluoride, lanthanum oxide and other suitable materials. Also the anti-reflective coating may be passivated by a protective cap layer.

If the determined differences are above the thresholds in step 123, the procedure is continued at a step 129 of processing the optical surface. For this purpose, the optical element is removed from the beam path of the interferometer optics and mounted on a suitable machine tool to remove those surface portions of the optical surface at which differences between the determined surface shape and the target shape exceed the threshold. Thereafter, the procedure is continued at step 115 and the optical element is again mounted in the beam of measuring light in the interferometer system, and the measurement of the surface shape of the optical surface, determining differences from the target shape and processing is repeated until the differences are below the thresholds.

The processing may include operations such as milling, grinding, loose abrasive grinding, polishing, ion beam figuring and magneto-rheological figuring.

After the optical surface is finished in step 125, the optical element is delivered and incorporated in the optical system in a step 127. Thereafter a next optical element to be tested is mounted in the interferometer beam path in step 115 and repeated measuring and machining of such next surface is performed until this surface fulfils the specifications.

The above threshold values will depend on the application of the optical surface in the optical system for which it is designed. For example, if the optical surface is a lens surface in an objective for imaging a reticle structure onto a resist with radiation of a wavelength λ=193 nm, such threshold value may be in a range of about 1 nm to 10 nm, and if the optical surface will be used as a mirror surface in an imaging objective using EUV (extreme ultraviolet) radiation with a wavelength of λ=13.5 nm, the threshold value will be in a region of about 0.1 nm to 1.0 nm. It is to be noted that it is not necessary that the above mentioned threshold is a constant threshold over the whole area of the optical surface. It is possible that the threshold is dependent on e.g. a distance from a center of the optical surface or some other parameters. In particular, plural thresholds may be defined each for different ranges of spatial frequencies of differences between the measured surface and its target shape.

In the above illustrated embodiments, the interferometer systems are of a Fizeau-type. It is to be noted, however, that the invention is not limited to such type of interferometer. Any other type of interferometer, such as a Twyman-Green-type of interferometer, examples of which are illustrated in chapter 2.1 of the text book edited by Daniel Malacara, Optical Shop Testing, 2nd edition, Wiley interscience Publication (1992), a Michelson-type interferometer, examples of which are illustrated in chapter 2.1 of the text book edited by Daniel Malacara, a Mach-Zehnder-type of interferometer, examples of which are illustrated in chapter 2.6 of the text book edited by Daniel Malacara, a point-diffraction type interferometer, examples of which are illustrated in U.S. Pat. No. 5,548,403 and in the article “Extreme-ultraviolet phase-shifting point-diffraction interferometer: a wavefront metrology tool with subangstrom reference-wave accuracy” by Patrick P. Naulleau et al., Applied Optics-IP, Volume 38, Issue 35, pages 7252 to 7263, December 1999, and any other suitable type of interferometer may be used.

It is further to be noted that the optical components involved in the above interferometric methods are subject to gravity during measurement. This may result in deformations of the surfaces of those components which are fixed in suitable mounts for arranging the components within the beam path of the interferometer. Even though the optical axis is oriented substantially horizontally in FIGS. 1 and 13, it is also possible to perform the same measurements with an optical axis oriented vertically in the gravitational field. In any event, it is possible to use mathematical methods to simulate deformations of the optical components in the gravitational field. One such method is known as FEM (finite element method). All determinations of optical properties and deviations illustrated above may involve taking into account results of such mathematical methods for correcting and/or improving the determined results.

Summarized, an embodiment of a method of qualifying a diffraction grating comprises performing plural measurements by illuminating a region of the grating with a beam of measuring light and detecting an intensity of measuring light diffracted by the grating into a 0th diffraction order. A wavelength of the measuring light or a polarization of the measuring light or an angle of incidence of the measuring light onto the diffraction grating is varied between subsequent measurements. A shape parameter of diffracting elements forming the grating comprises a pitch, height or width of structural features of the diffracting elements. The shape parameter is advantageously used in analyzing interferometric measurements performed on optical surfaces during manufacture of optical elements of a high accuracy.

The present invention has been described by way of exemplary embodiments to which it is not limited. Variations and modifications will occur to those skilled in the art without departing from the scope of the present invention as recited in the appended claims and equivalents thereof.

The invention claimed is:

1. A method of qualifying at least one region of a diffraction grating, the grating having a plurality of diffracting elements arranged in a repetitive pattern in the at least one region, the method comprising:
performing plural measurements, each measurement comprising:
illuminating the at least one region of the grating with a first beam of measuring light, and
detecting an intensity of measuring light of the first beam diffracted by the grating into a 0th diffraction order; and
determining at least one value of a property of the diffracting elements of the grating within the illuminated region based on the intensities detected in the plural measurements;
wherein at least one of the following conditions is fulfilled:
the measuring light of the first beam in a first measurement of the plural measurements has a wavelength which is different from a wavelength of the measuring light of the first beam in a second measurement of the plural measurements; and
the measuring light of the first beam in the first measurement has a polarization relative to the grating which is different from a polarization of the measuring light of the first beam in the second measurement.

2. The method according to claim 1, wherein the following relation is fulfilled:
$$2 \frac{\vert {λ}_{1} - {λ}_{2} \vert}{( {λ}_{1} + {λ}_{2} )} > 0.001 ,$$
wherein:
λ₁ is the wavelength of the measuring light of the first beam in the first measurement, and
λ₂ is the wavelength of the measuring light of the first beam in the second measurement.

3. The method according to claim 1, wherein the following relation is fulfilled:
$$2 \frac{\vert {I}_{1} - {I}_{2} \vert}{( {I}_{1} + {I}_{2} )} > 0.10 ,$$
wherein:
I₁ represents a relative intensity of light of the measuring light of the first beam in a polarization direction in the first measurement, and
I₂ represents a relative intensity of light of the measuring light of the first beam in the polarization direction in the second measurement.

4. The method according to claim 3, wherein the polarization direction has an orientation with respect to a direction of extension of the diffracting elements of the grating in the illuminated region, the orientation being one of transverse and parallel to the direction of extension.

5. The method according to claim 1, wherein an angle of incidence of the first beam in a third measurement onto the grating is different from an angle of incidence of the first beam in a fourth measurement.

6. The method according to claim 5, wherein the following relation is fulfilled:
$$2 \frac{\vert {β}_{1} - {β}_{2} \vert}{( {β}_{1} + {β}_{2} )} > 0.10 ,$$
wherein:
β₁ represents the angle of incidence of the first beam onto the grating in the third measurement, and
β₂ represents the angle of incidence of the first beam onto the grating in the fourth measurement.

7. The method according to claim 1, wherein the property represents at least one of a width of the repetitively arranged diffracting elements, a height of the diffracting elements, a pitch of the diffracting elements, a direction of extension of the diffracting elements and a slope angle of the diffracting elements.

8. The method according to claim 1, wherein the at least one value is calculated based on a solution of Maxwell's equations for a predetermined geometry of the grating.

9. The method according to claim 1, wherein the grating is provided in a first portion of a grating carrying substrate and wherein the substrate has a second portion which is free of diffracting elements, the method further comprising a calibration by:
illuminating the second portion of the substrate with the first beam of measuring light, and
detecting an intensity of measuring light having interacted with the second portion.

10. The method according to claim 1, further comprising qualifying plural regions of the diffraction grating by displacing the diffraction grating relative to the first beam of measuring light between a first pair of first and second measurements and a subsequent second pair of first and second measurements.

11. The method according to claim 1, further comprising qualifying plural regions of the diffraction grating by simultaneously illuminating the plural regions of the diffraction grating with the first beam of measuring light and detecting plural intensities of the measuring light diffracted by the grating into the 0th diffraction order.

12. The method according to claim 11, wherein the plural intensities are detected with a detector having plural detector elements.

13. The method according to claim 12, wherein the plural detector elements are arranged in one of a linear array and a two dimensional array.

14. The method according to claim 1, wherein the detected light has traversed the grating.

15. The method according to claim 1, wherein the detected light is reflected from the grating.

16. A method of producing a computer readable data carrier, the method comprising:
performing plural measurements at a region of a grating, each measurement comprising:
illuminating the region of the grating with a first beam of measuring light, and
detecting an intensity of measuring light of the first beam diffracted by the grating into a 0th diffraction order;
wherein at least one of the following conditions is fulfilled:
the measuring light of the first beam in a first measurement of the plural measurements has a wavelength which is different from a wavelength of the measuring light of the first beam in a second measurement of the plural measurements; and
the measuring light of the first beam in the first measurement has a polarization relative to the grating which is different from a polarization of the measuring light of the first beam in the second measurement;
wherein the method further comprises:
determining a data structure based on the intensities detected in the plural measurements;
producing the data carrier embodying the data structure.

17. The method according to claim 16, wherein the plural measurements are repeatedly performed at plural regions of the grating, and wherein the data structure is determined based on the intensities detected in the plural measurements at the plural locations.

18. The method according to claim 17, wherein the data structure comprises a representation of a phase function of the grating.

19. A method of manufacturing an optical element having an optical surface of a target shape, the method comprising:
performing plural measurements at a region of a grating, each measurement comprising:
illuminating the at least one region of the grating with a first beam of measuring light, and
detecting an intensity of measuring light of the first beam diffracted by the grating into a 0th diffraction order; and
wherein at least one of the following conditions is fulfilled:
the measuring light of the first beam in a first measurement of the plural measurements has a wavelength which is different from a wavelength of the measuring light of the first beam in a second measurement of the plural measurements; and
the measuring light of the first beam in the first measurement has a polarization relative to the grating which is different from a polarization of the measuring light of the first beam in the second measurement; and
wherein the method further comprises:
determining at least one value of a property of the diffracting elements of the grating within the illuminated region based on the intensities detected in the plural measurements;
directing a second beam of measuring light through an interferometer optics onto the optical surface, the interferometer optics comprising the diffraction grating for diffracting the second beam of measuring light;
performing at least one interferometric measurement by superimposing reference light with measuring light having interacted with the optical surface;
determining deviations of the optical surface from the target shape based on the at least one interferometric measurement and the at least one determined value; and
processing the optical surface of the optical element based on the determined deviations.

20. The method according to claim 19 wherein the diffraction grating is a phase grating configured such that an intensity of measuring light of the second beam diffracted into a 0th diffraction order is less than an intensity of measuring light of the second beam diffracted into a 1st diffraction order.

21. The method according to claim 19 wherein the diffraction grating is a phase grating configured such that an intensity of measuring light of the second beam diffracted into a 0th diffraction order is less than 10% of an intensity of measuring light of the second beam diffracted into a 1st diffraction order.

22. The method according to claim 19 wherein a wavelength of the first beam of measuring light is different from a wavelength of the second beam of measuring light and wherein the following relation is fulfilled:
$$2 \frac{\vert {λ}_{3} - {λ}_{4} \vert}{( {λ}_{3} + {λ}_{4} )} > 0.001$$
wherein:
λ₃ is the wavelength of the measuring light of the first beam, and
λ₄ is the wavelength of the measuring light of the second beam.

23. The method according to claim 19, wherein the following relation is fulfilled:
$$2 \frac{\vert {λ}_{1} - {λ}_{2} \vert}{( {λ}_{1} + {λ}_{2} )} > 0.001$$
wherein:
λ₁ is the wavelength of the measuring light of the first beam in the first measurement, and
λ₂ is the wavelength of the measuring light of the first beam in the second measurement.

24. The method according to claim 19, wherein the following relation is fulfilled:
$$2 \frac{\vert {I}_{1} - {I}_{2} \vert}{( {I}_{1} + {I}_{2} )} > 0.10 ,$$
wherein:
I₁ represents a relative intensity of light of the measuring light of the first beam in a polarization direction in the first measurement, and
I₂ represents a relative intensity of light of the measuring light of the first beam in the polarization direction in the second measurement.

25. The method according to claim 24, wherein the polarization direction has an orientation with respect to a direction of extension of the diffracting elements of the grating in the illuminated region, the orientation being one of transverse and parallel to the direction of extension.

26. The method according to claim 19, wherein the following relation is fulfilled:
$$2 \frac{\vert {β}_{1} - {β}_{2} \vert}{( {β}_{1} + {β}_{2} )} > 0.10$$
wherein:
β₁ represents the angle of incidence of the first beam onto the grating in the first measurement, and
β₂ represents the angle of incidence of the first beam onto the grating in the second measurement.

27. The method according to claim 19, wherein the property comprises at least one of a width of the repetitively arranged diffracting elements, a height of the diffracting elements, a pitch of the diffracting elements, a direction of extension of the diffracting elements and a slope angle of the diffracting elements.

28. The method according to claim 19, wherein the grating is provided in a first portion of a grating carrying substrate and wherein the substrate has a second portion which is free of diffracting elements, the method further comprising a calibration by:
illuminating the second portion of the substrate with the first beam of measuring light, and
detecting an intensity of measuring light having interacted with the second portion.

29. The method according to claim 19, further comprising qualifying plural regions of the diffraction grating by displacing the diffraction grating relative to the first beam of measuring light between a first pair of first and second measurements and a subsequent second pair of first and second measurements.

30. The method according to claim 19, further comprising qualifying plural regions of the diffraction grating by simultaneously illuminating the plural regions of the diffraction grating with the first beam of measuring light and detecting plural intensities of the measuring light diffracted by the grating into the 0th diffraction order.

31. The method according to claim 30, wherein the plural intensities are detected with a detector having plural detector elements.

32. The method according to claim 19, wherein the second beam of measuring light is reflected from the optical surface.

33. The method according to claim 19, wherein the second beam of measuring light traverses the optical surface.

34. The method according to claim 19, wherein the interferometer optics comprises a Fizeau surface from which the reference light is reflected and which is traversed by the beam of measuring light.

35. The method according to claim 19, wherein the optical surface has an aspherical shape.

36. The method according to claim 19, wherein the machining of the optical surface of the optical element comprises at least one of milling, grinding, loose abrasive grinding, polishing, ion beam figuring, magneto-rheological figuring, and finishing the optical surface of the optical element.

37. The method according to claim 36, wherein the finishing comprises applying a coating to the optical surface.

38. The method according to claim 35, wherein the coating comprises at least one of a reflective coating, an anti-reflective coating and a protective coating.

39. A method of manufacturing an optical element having an aspherical optical surface, the method comprising:
performing at least one interferometric measurement by superimposing reference light with measuring light having interacted with the aspherical optical surface, using an interferometer apparatus comprising an interferometer optics including a hologram; and
processing the optical surface of the optical element based on the at least one interferometric measurement and based on prestored data values indicative of phase errors produced by the hologram during the interferometric measurement.
